(19) United States
(12) Patent Application Publication
(10) Pub. No.: US 2012/0074286 A1
(43) Pub. Date: Mar. 29, 2012

(54) Foldable support base

(76) Inventor: Chun-Chien Chou, Taipei (TW)

(21) Appl. No.: 13/137,645

(22) Filed: Aug. 31, 2011

(30) Foreign Application Priority Data
Sep. 24, 2010 (TW) 099218435

(51) Int. Cl. F16M 13/00

(52) U.S. Cl. 248/346.03; 248/346.3

(57) ABSTRACT

A foldable support base includes a first board, a second board, and a third board. The first board has an edge forming a positioning section. A surface of the first board and a surface of the positioning section of the first board are provided with a first pad for protection against scratching. The second board has an edge that is in movable pivoting joint with an opposite edge of the first board. The third board has an edge that is in movable pivoting joint with an opposite edge of the second board. The second and third boards are provided with at least one second pad to protect against scratching and to prevent undesired movement. The above described arrangement helps, in either expanded or folded condition, reducing overall volume for easy carrying and protecting against damage caused by scratching and also providing a function of secure positioning and retention.

### FIELD OF THE INVENTION

The present invention relates to a foldable support base, and in particular to a foldable support base that, when put in use, may position and support a computer peripheral device, and, after use, may be readily folded and stowed for easy carrying.

### BACKGROUND OF THE INVENTION

After the development and market availability of tablet computers, the population of fans of tablet computer is gradually getting larger for the tablet computer is functionally equivalent to a notebook computer, but is compact in size and light is weight as compared to the notebook computer and is easy to carry so as to make it popular. However, using a tablet computer must place the computer flat on for example a desktop, for the tablet computer itself is not provided with built in support for erecting up the computer. To meet various needs of the general users, a lot of support bases have been developed for supporting the tablet computer. There are different kinds of support base are available in the market, which are all effective in supporting a tablet computer. However, these known support bases generally occupy a large amount of space when not in use, making it difficult to stow and carry.

Thus, the present invention aims to provide a foldable support stand that can be readily stowed and is easy carrying after being used to position or support a tablet computer.

### SUMMARY OF THE INVENTION

An objective of the present invention is to provide a foldable support base, which comprises boards that are set in movable pivoting joint with each other so that, in a stowed condition, folding can be done to provide a compact size for easy carrying, use, and operation.

Another objective of the present invention is to provide a foldable support base, which comprises an arrangement of first pad and second pad to provide the advantages of protection against scratching and secure retention in the use thereof.

To achieve the above objectives, the present invention provides a foldable support base, which comprises a first board, a second board, and a third board. The first board has an edge forming a positioning section. The second board has an edge that is in movable pivoting joint with an opposite edge of the first board. The third board has an edge that is in movable pivoting joint with an opposite edge of the second board. The positioning section of the first board forms a first receptacle channel. A surface of the first board and a surface of the positioning section of the first board are provided with a first pad. A bottom of the positioning section of the first board is provided with at least one second pad. The opposite edge of the first board forms a first receiving section. The edge of the second board forms a first pivot joint section. The first receiving section and the first pivot joint section are set in movable pivoting joint with each other. The opposite edge of the second board forms a second pivot joint section. The edge of the third board forms a second receiving section. The second pivot joint section and the second receiving section are set in movable pivoting joint with each other. A surface of the second board and a surface of the third board are provided with at least one second pad. The third board has an opposite edge that forms a second receptacle channel for receiving and removably retaining therein a touch control stylus.

With such an arrangement, in either an expanded condition or a folded condition, the advantages of reduction of size for easy carrying, protection against scratching, and secure retention can be realized.

### BRIEF DESCRIPTION OF THE DRAWINGS

The present invention will be apparent to those skilled in the art by reading the following description of preferred embodiments thereof with reference to the drawings, in which:

FIG. 1 is a perspective view showing a foldable support base constructed in accordance with a first embodiment of the present invention in an expanded condition;

FIG. 2 is a side elevational view of the foldable support base according to the first embodiment of the present invention in a folded condition;

FIGS. 3-6 are perspective views illustrating various ways of use of the foldable support base according to the first embodiment of the present invention;

FIG. 7 is a perspective view showing a foldable support base constructed in accordance with a second embodiment of the present invention;

FIG. 8 is a side elevational view showing a foldable support base constructed in accordance with a third embodiment of the present invention in a folded condition; and

FIGS. 9 and 10 are side elevational views respectively showing different configurations of folded conditions of the foldable support base according to the third embodiment of the present invention.

### DETAILED DESCRIPTION OF THE PREFERRED EMBODIMENTS

First Embodiment

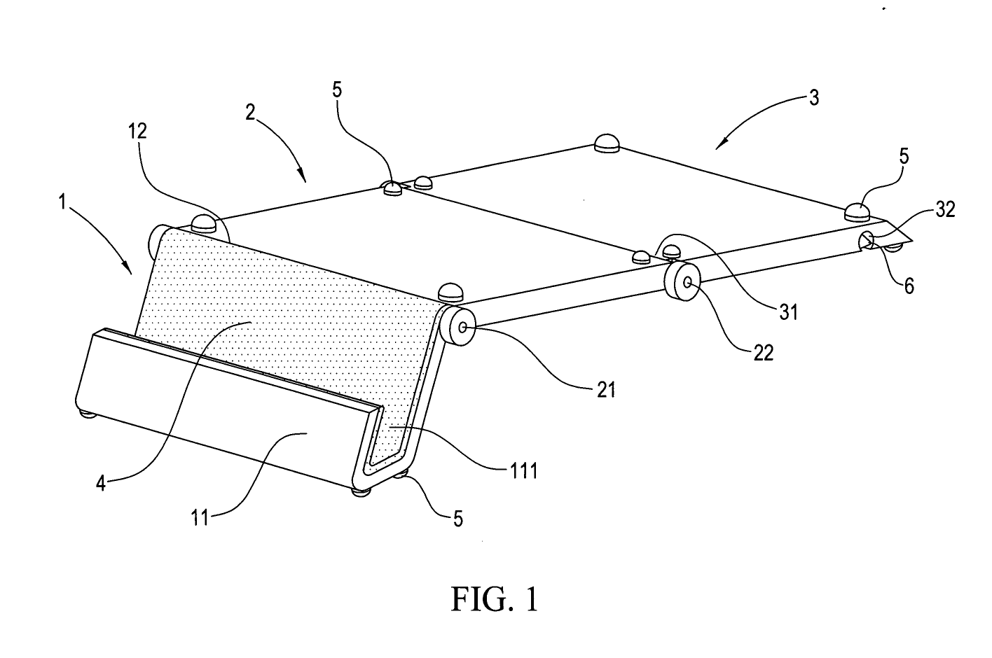

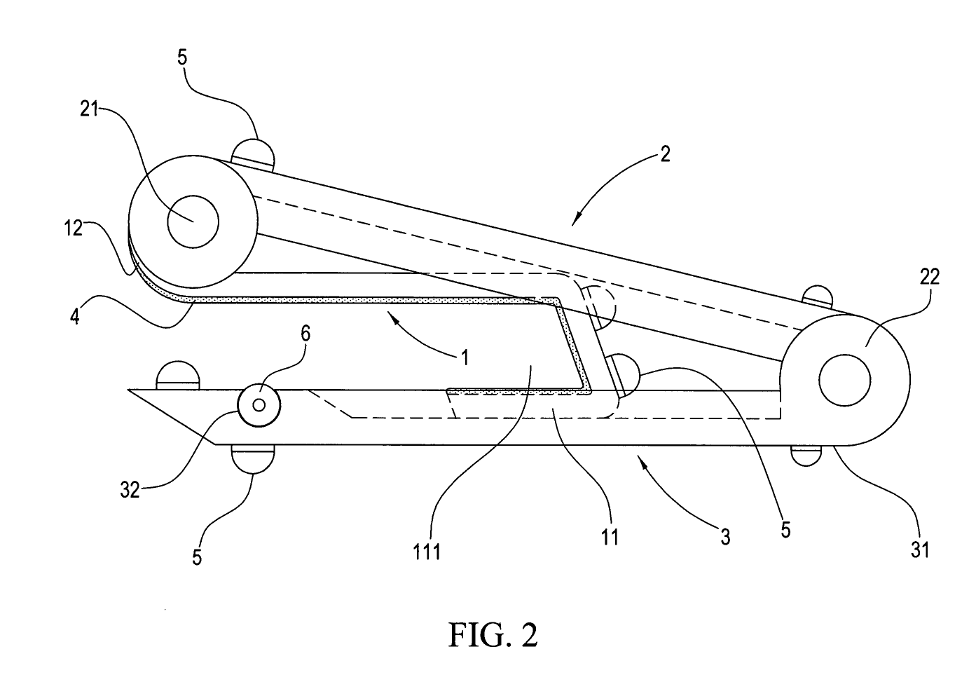

With reference to the drawings and in particular to FIGS. 1 and 2, the present invention provides a foldable support base, which comprises: a first board 1, a second board 2, and a third board 3.

The first board 1 has a first edge that forms a positioning section 11. The second board 2 has a first edge that is in movable pivoting joint with an opposite, second edge of the first board 1. The third board 3 has a first edge that is in movable pivoting joint with an opposite, second edge of the second board 2.

The positioning section 11 of the first board 1 forms a first receptacle channel 111. A first pad 4 is provided on the surface of the first board 1 and the surface of the positioning section 11 of the first board 1. At least one second pad 5 is provided on the bottom of the positioning section 11 of the first board 1. The second edge of the first board 1 forms a first receiving section 12. The second edge of the second board 2 forms a first pivot joint section 21. The first receiving section 12 is set in movable pivoting joint with the first pivot joint section 21. The second edge of the second board 2 forms a second pivot joint section 22. The first edge of the third board 3 forms a second receiving section 31. The second pivot joint section 22 is set in movable pivoting joint with the second receiving section 31. At least one second pad 5 is provided on the surface of the second board 2 and the surface of the third board 3. At least one second pad 5 is provided on the bottom of the third board 3. The second pad 5 can be in the form of a strip, a plate, or a curved configuration. The third board 3 forms, in the second edge thereof, a second receptacle channel 32 that receives and releasably retains therein a touch control stylus 6.

After expansion, the positioning section 11 of the first board 1 and the second edge of the third board 3 are positionable on for example a desktop with the first receiving section 12 of the first board 1 and the first pivot joint section 21 of the second board 2 being set in an angular position with respect to each other. To fold, due to the movable pivoting joint between the first receiving section 12 of the first board 1 and the first pivot joint section 21 of the second board 2, the positioning section 11 of the first board 1 is allowed to move toward the bottom of the second board 2 for folding. Then, the movable pivoting joint between the second receiving section 31 of the third board 3 and the second pivot joint section 22 of the second board 2 allows the second edge of the third board 3 to be moved toward the positioning section 11 of the first board 1 for further folding so as to complete the folding and stowing of the foldable support base according to the present invention.

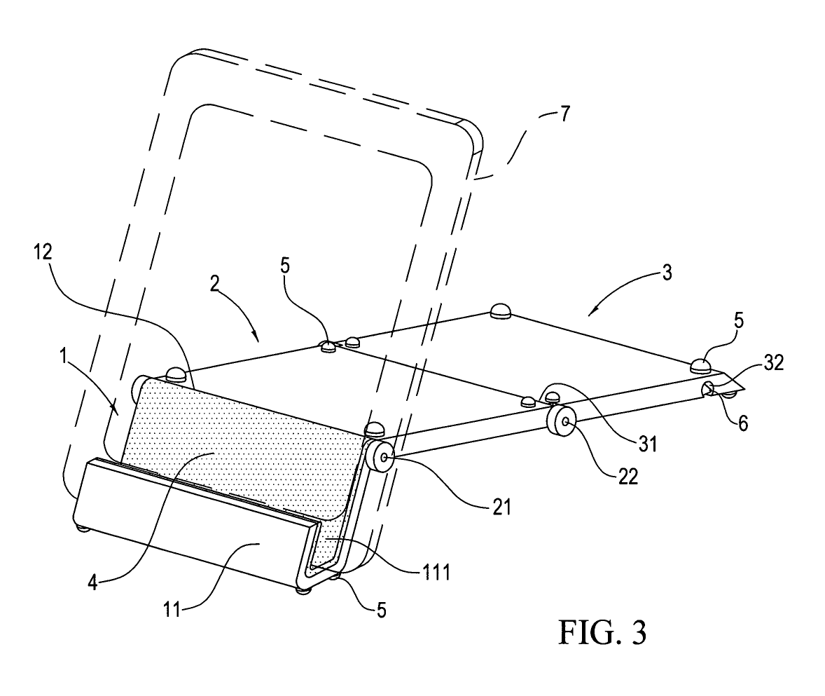

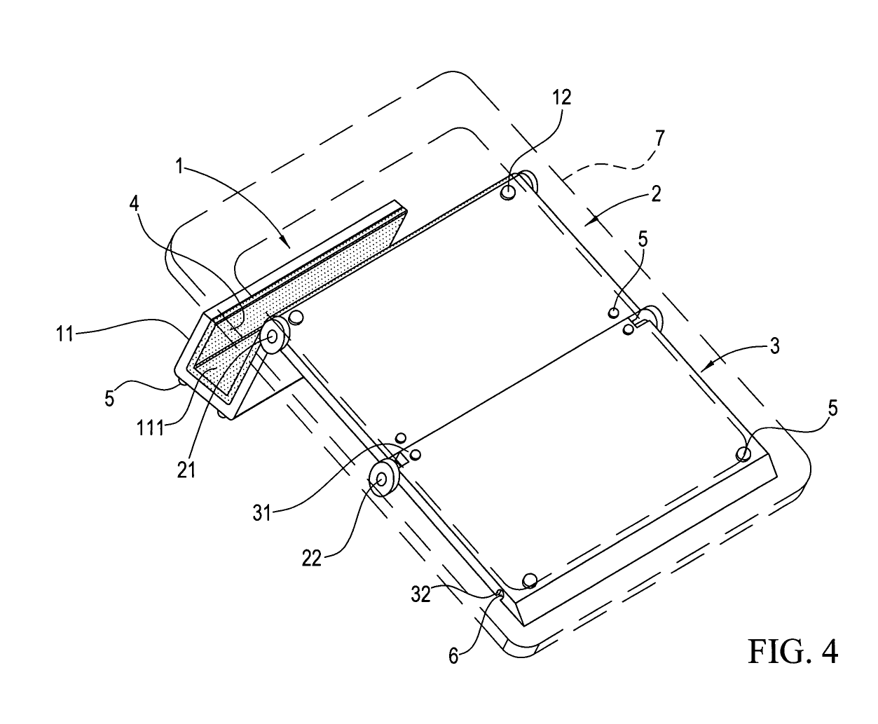

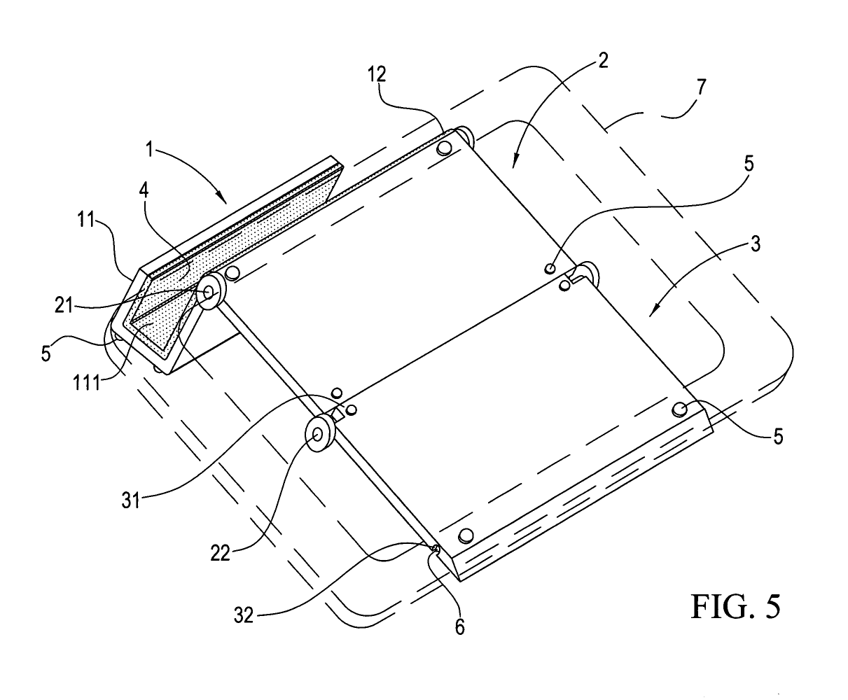

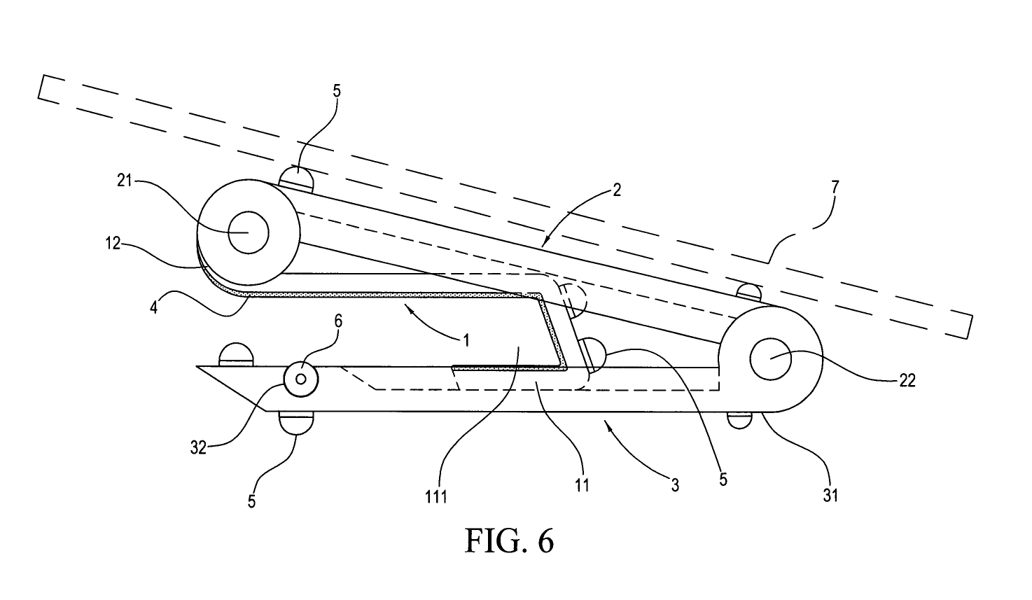

Referring to FIGS. 3-6, the present invention is useful in an expanded condition and a folded condition. In the expanded condition, a tablet computer 7 can be placed and retained, in either a vertical position or a horizontal position, in the first receptacle channel 111 of the positioning section 11 of the first board 1. The first pads 4 that are provided on the first board 1 and the receptacle channel 111 of the positioning section 11 help protecting the outside appearance of the tablet computer 7 from damage caused by scratching. Further, the first pad 4 also helps increasing frictional force to more securely and stably hold the tablet computer 7 in the positioning section 11. The tablet computer 7 can be selectively placed flat on the second board 2 and the third board 3. The second board 2 and the third board 3 are provided thereon with at least one the second pad 5, which helps increasing frictional force to more securely and stably hold the tablet computer 7 and preventing undesired sliding down, so as to protect the outside appearance of the tablet computer 7 from damage caused by scratching. Further, the first board 1 and the second board 2 are set to form an included angle therebetween and such an angle is selected to help a user to do typewriting on a virtual keyboard. In the folded condition, after the first board 1 and the third board 3 are folded and overlapped on the bottom of the second board 2, the present invention shows a substantially triangular configuration that allows the third board 3 to be positioned flat on for example a desktop with the second board 2 being set inclined. A tablet computer 7 may then be positioned flat on the second board 2.

Second Embodiment

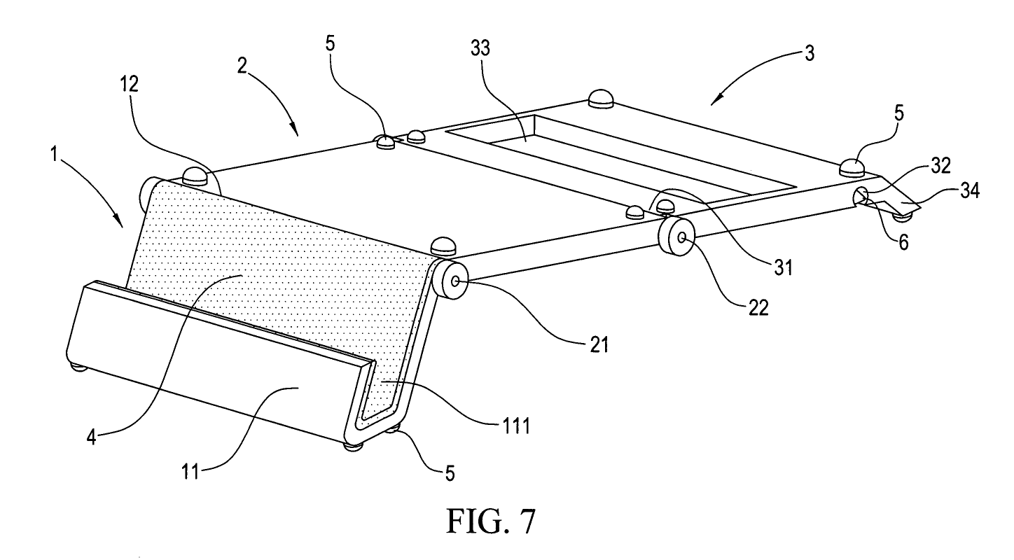

Referring to FIG. 7, a second embodiment according to the present invention is provided and the second embodiment comprises elements and functionalities that are substantially identical to those of the first embodiment described above, so that repeated description will be omitted. However, it is noted that in the second embodiment, the third board 3 is modified to form a storage space 33 and a stand section 34. As shown in the drawing, the third board 3 forms a storage space 33, which removably receives the positioning section 11 therein, whereby when the present invention is folded, the storage space 33 corresponds to and receives the positioning section 11 of the first board 1 (this condition being not illustrated in the drawing). The storage space 33 of the third board 3 can be an opening or a recess. The stand section 34 is arranged on the second edge of the third board 3 and the stand section 34 has a bottom to which at least one the second pad 5 is mounted.

Third Embodiment

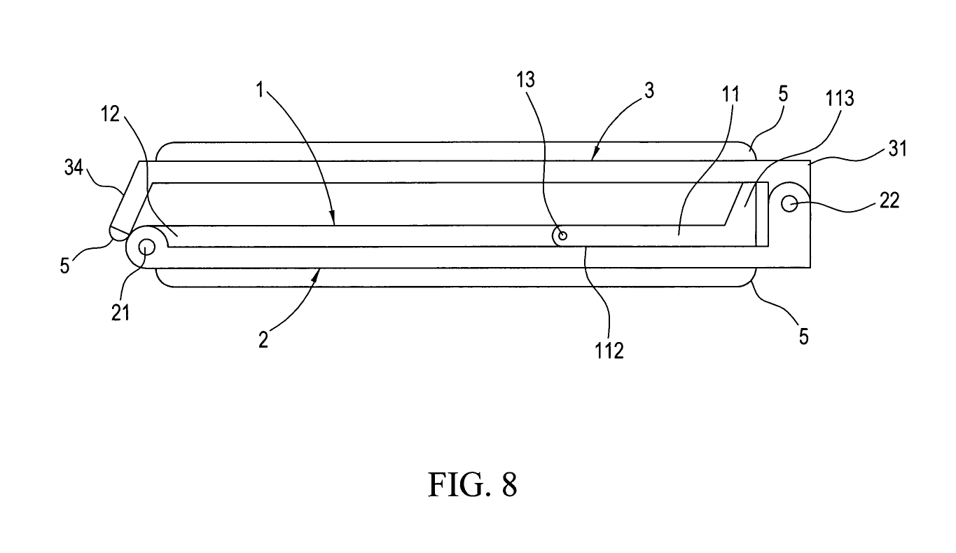

Referring to FIGS. 8-10, a third embodiment according to the present invention is illustrated, which provides an even more compact size after folding of the foldable support base of the present invention for easy carrying and is different from the first and second embodiments described previously in that the positioning section 11 is set in movable pivoting joint with the first edge of the first board 1, wherein the first edge of the first board 1 forms a third pivot joint section and an edge of the positioning section 11 that is pivoted to the third pivot joint section forms a third receiving structure 112, so as to facilitate the first board 1 and the positioning section 11 to be folded and stowed between the second board 2 and the third board 3.

In the different folded condition of the foldable support base according to the third embodiment, the first board 1 and the positioning section 11 that are received between the second board 2 and the third board 3 show an “extended” flat condition as shown in FIG. 8, making them in a flat and straight configuration. Further, the positioning section 11 has an opposite edge that forms a support structure 113 that allows the second board 2 and the third board 3 to be positioned thereon for folding and positioning. On the other hand, when the foldable support base shown in the drawing is expanded, the first receptacle channel 111 of the positioning section 11 may function to receive an article (such as a tablet computer, not shown in the drawing) to be positioned therein. The support structure 113 of the positioning section 11 provides a function of retention that prevents the article positioned in the first receptacle channel 111 from undesired falling and sliding.

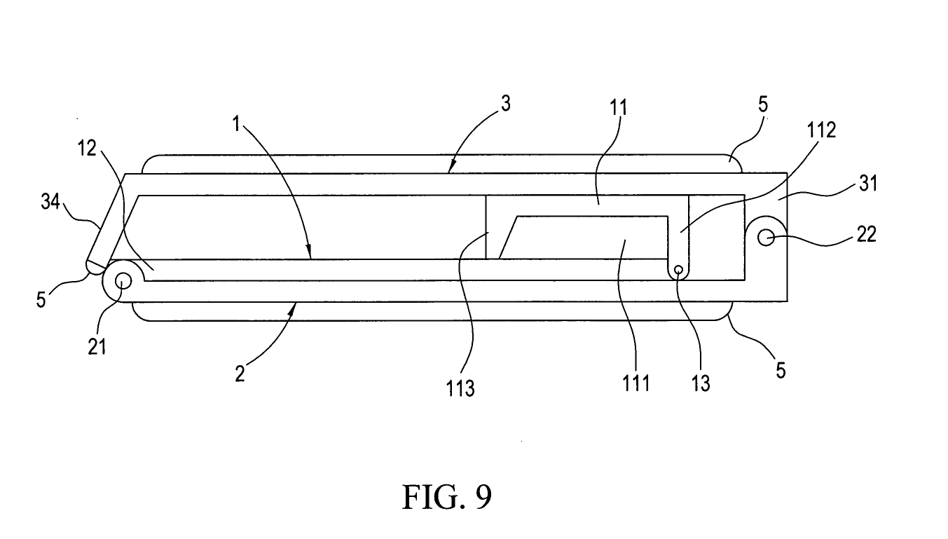

Further, the foldable support base is not limited to the folded configuration shown in FIG. 8 and may be arranged as that shown in FIG. 9, where the positioning section 11 is over-turned in folding so that the positioning section 11 and the first board 1 show a stacked condition with the first board 1 overlapping the second board 2 and the positioning section 11 overlapping the third board 3. Further, the third receiving structure 112 is set in a curved configuration and said opposite edge of the positioning section 11 forms the support structure 113 to allow the first board 1 and the third board 3 to be positioned thereon and thus facilitating folding and positioning of the second board 2 and the third board 3 and to provide the positioning section 11 with a first receptacle channel 111. On the other hand, when the foldable support base shown in the drawing is expanded, the first receptacle channel 111 of the positioning section 11 may function to receive an article (such as a tablet computer, not shown in the drawing) to be positioned therein. The support structure 113 of the positioning section 11 provides a function of retention that prevents the article positioned in the first receptacle channel 111 from undesired falling and sliding.

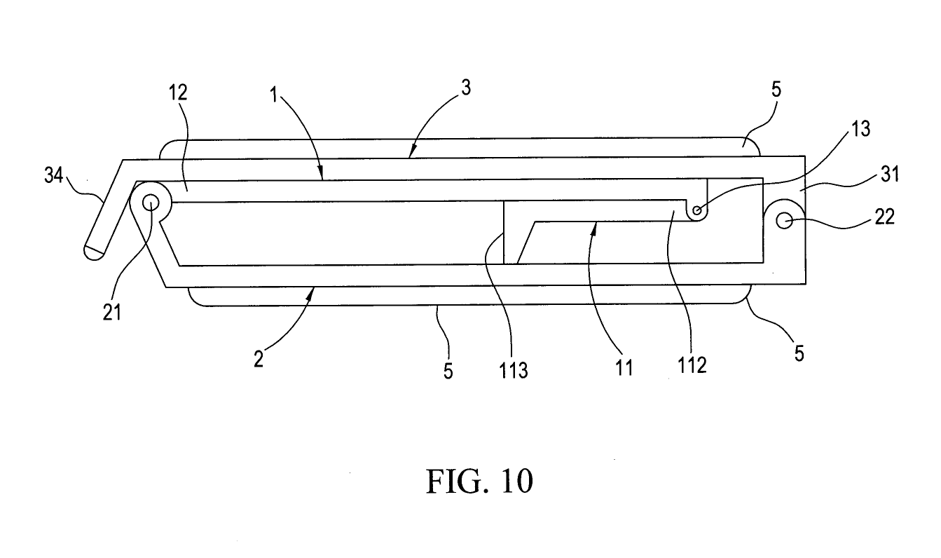

Further, the foldable support base can be manipulated as shown in FIG. 10, where the positioning section 11 is turned in a reversed direction to overlap the first board 1 and the first board 1 overlaps the third board 3. Said opposite edge of the positioning section 11 forms the support structure 113 to allow the first board 1 and the second board 2 to be positioned thereon and thus facilitating folding and positioning of the second board 2 and the third board 3. On the other hand, when the foldable support base shown in the drawing is expanded, the first receptacle channel 111 of the positioning section 11 may function to receive an article (such as a tablet computer, not shown in the drawing) to be positioned therein. The support structure 113 of the positioning section 11 provides a function of retention that prevents the article positioned in the first receptacle channel 111 from undesired falling and sliding.

As such, the foldable support base according to the third embodiment uses the combination of the first board 1 and the positioning section 11 to prevent the positioning section 11 and the first board 1 for shaking and thus hitting the boards to generate noise. Further, when the foldable support base is expanded, free adjustment of the configuration between the positioning section 11 and the first board 1 is allowed to properly receive an article to be positioned in the first receptacle channel 111 and also prevents the article received in the first receptacle channel 111 from falling and constrains undesired sliding and movement of the article.

Further, in the embodiment, to accommodate the configurations between the first board 1 and the positioning section 11, adjustment of structural arrangements between the first receiving section 12 and the first pivot joint section 21, between the second pivot joint section 22 and the second receiving section 31, and between the third pivot joint section and the third receiving structure 112 can be made to show a bent or curved configuration, so that, after folded, the foldable support base displays a flat and neat appearance.

In summary, the foldable support base according to the present invention shows the follows advantages:

Through the movable pivoting joints between the first board 1, the second board 2, and the third board 3, to stow, the present invention can be folded to reduce the volume so as to facilitate easy carrying, use, and operation.

Through the arrangement of the first pad 4 and the second pad 5, frictional forces between the present invention and the tablet computer 7 are increased to realize protection against scratching and secure retention and positioning.

Through a movable pivoting joint formed between the first board 1 and the positioning section 11, the prevent invention, after folded, shows an even smaller volume, neater, and more aesthetic appearance and also makes more secure positioning among the boards to thereby facilitate easy carrying.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A foldable support base, comprising:
a first board, which has a first edge forming a positioning section;
a second board, which has a first edge that is in movable pivoting joint with an opposite, second edge of the first board; and
a third board, which has a first edge that is in movable pivoting joint with an opposite, second edge of the second board.

2. The foldable support base as claimed in claim 1, wherein the positioning section of the first board forms a first receptacle channel.

3. The foldable support base as claimed in claim 1, wherein the second edge of the first board forms a first receiving section, the first edge of the second board forming a first pivot joint section, the first receiving section and the first pivot joint section being in movable pivoting joint with each other.

4. The foldable support base as claimed in claim 1, wherein the second edge of the second board forms a second pivot joint section, the second edge of the third board forming a second receiving section, the second pivot joint section and the second receiving section being in movable pivoting joint with each other.

5. The foldable support base as claimed in claim 1, wherein a surface of the first board and a surface of the positioning section of the first board are provided with a first pad.

6. The foldable support base as claimed in claim 1, wherein a bottom of the positioning section of the first board is provided with at least one second pad.

7. The foldable support base as claimed in claim 1, wherein a surface of the second board and a surface of the third board are provided with at least one second pad.

8. The foldable support base as claimed in claim 6 or 7, wherein the second pad is in the form of a strip, a plate, or a curved configuration.

9. The foldable support base as claimed in claim 1, wherein the third board forms a storage space, which removably receives the positioning section of the first board.

10. The foldable support base as claimed in claim 1, wherein the third board forms a stand section, which is arranged at an opposite, second edge of the third board.

11. The foldable support base as claimed in claim 9, wherein the storage space of the third board comprises an opening or a recess.

12. The foldable support base as claimed in claim 10, wherein the stand section of the third board has a bottom to which at least one second pad is mounted.

13. The foldable support base as claimed in claim 1, wherein the third board forms a second receptacle channel adapted to receive and releasably retain therein a touch control stylus.

14. The foldable support base as claimed in claim 1, wherein the positioning section is in movable pivoting joint with an edge of the first board, the edge of the first board forming a third pivot joint section, an edge of the positioning section forming a third receiving structure pivotally coupled to the third pivot joint section so as to facilitate the first board and the positioning section to be folded and stowed between the second board and the third board.

15. The foldable support base as claimed in claim 14, wherein in a folded condition, the first board and the positioning section that are received between the second board and the third board show an extended flat condition, the positioning section having an opposite edge forming a support structure that allows the second board and the third board to be positioned thereon for folding and positioning.

16. The foldable support base as claimed in claim 14, wherein in a folded condition, first board and the positioning section that are received between the second board and the third board are arranged to show a stacked condition with the first board overlapping the second board and the positioning section overlapping the third board, the positioning section having an opposite edge forming a support structure that allows the first board and the third board to be positioned thereon.

17. The foldable support base as claimed in claim 14, wherein in a folded condition, the first board and the positioning section that are received between the second board and the third board overlap each other and the first board overlap the third board, the positioning section having an opposite edge forming a support structure that allows the first board and the second board to be positioned thereon.
